(19) United States
(12) Patent Application Publication
(10) Pub. No.: US 2022/0144572 A1
(43) Pub. Date: May 12, 2022

(54) MEASURING DEVICE

(71) Applicant: Hewlett-Packard Development Company, L.P., Spring, TX (US)

(72) Inventor: Ofek Shtibel, Kiryat-Gat (IL)

(73) Assignee: Hewlett-Packard Development Company, L.P., Spring, TX (US)

(21) Appl. No.: 17/418,041

(22) PCT Filed: Jul. 29, 2019
(86) PCT No.: PCT/US2019/043954

§ 371 Date: Jun. 24, 2021

(51) Int. Cl. B65H 9/20

(52) U.S. Cl. CPC B65H 9/20

(57) ABSTRACT

An apparatus is disclosed comprising a digital print press having a measuring device. The device comprises a light transmitting planar surface and a light source behind the surface to backlight the surface and project light through the surface. An opaque scale may be provided on the surface to provide visible scale markings projected through printed media placed upon the surface.

### BACKGROUND

In printing processes, such as commercial printing using digital print presses, manual alignment or measuring tasks may be regularly carried out. Such tasks can be time-consuming and incur cost in operator-hours. For example, there may be a need to measure print quality defects to help identify their cause. Another example is the need to check front-to-back alignment in two sided prints. Substrates may also need accurate measurement to avoid, or reduce the risk of, paper jams within the press.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a schematic three-dimensional view of a first example of the present disclosure;

FIG. 2 is a schematic top view of an example;

FIG. 3 is a schematic of a print press incorporating an example; and

FIG. 4 illustrates the example of FIG. 2 in use.

### DETAILED DESCRIPTION

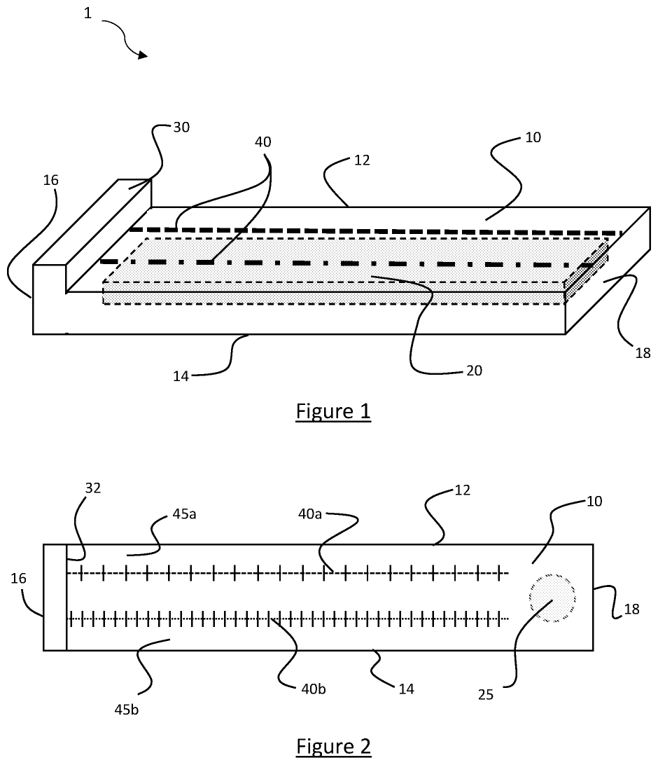

A measuring and alignment device 1 for use with print media is shown in FIGS. 1 and 2. The apparatus comprises a surface 10 beneath which is mounted a light source 20. A scale 40 is provided on the surface and is opaque such that it may partially block light from the light source 20. When activated the light source 20 will backlight the surface 10 and project light through a printed media placed upon the surface 10. The opaque scale 40 blocks light transmission such that visible scale markings can be seen through the printed media.

The surface 10 of the measuring device 1 is elongate and may extend lengthwise from a first end 16 to a second end 18 and widthwise from a first side 12 to a second side 14. The surface 10 is formed from a light transmitting material which may for example be transparent or translucent. In some examples the material of the surface may be a diffuser. As such the surface 10 may help spread and distribute the light from the light source 20. The measuring device 1 may for example be formed from a thermoplastic material for example Polycarbonate (although other materials such as Poly(methyl methacrylate) may be used in other examples) .

The light source 20 may be embedded within the material from which the surface 10 is formed as shown by the outline in FIG. 1. The light source 20 may for example comprise an LED or LED array. The light source 20 may comprise a plurality of LED distributed along the underside of the surface 10. Alternatively or additionally, a light transmitting member (for example a light tube) can be used to distribute light around the underside of the surface. The LED or LEDs can be white LEDs. The LEDs may for example comprise an array of LEDs mounted on surface circuit board. For example, an LED strip or ribbon may be provided on a flexible circuit board which extends along at least a portion of the length of the surface 10. The light source 20 may be a high intensity LED light source, for example having an intensity of between 5400 to 7000 Lumens. The selection of an appropriate intensity LED may allow examples of the disclosure to be used with substrates having a significant thickness (of, for example, up to 350 GSM) which may otherwise present difficulties in accurate alignment or measurement.

The light source 20 may be a variable intensity light source. For example, the light source may be dimmable (which may include pulsed width modulation dimming). A switch, such as a touch sensitive switch, 25 can be provided for controlling the light source 20. In some examples, the switch 25 may be a simple on/off selector or may enable light intensity variation (for example cycling through several different brightness settings).

At one end 16 of the surface an alignment guide 30 may be provided which projects outwardly from the surface 10. The alignment guide 30 may extend along the full width of the end 1. The alignment guide of the example provides an alignment edge 32 which is perpendicular to the plane of the surface 10 and to the longitudinal axis of the measuring device 1. The alignment edge 32 of the alignment guide 30 may provide a “0” or “stopper” this helps to ensure that the edge of a piece of printed media can be accurately aligned when a measurement is taken using the scale 40.

As best seen in the plan view of FIG. 2, the measuring device 1 may be provided with multiple scales 40a and 40b. Each scale 40a, 40b may extend in parallel along a longitudinal axis of the device 10 (and can therefore be parallel to one another). For example, the scales may be provided for different measurement purposes or in alternate units (for example SI units and Imperial units). The scales 40a and 40b may be provided with major and minor scale markings which may assist in accurate measuring. As shown in the example, a margin area 45a and 45b which is devoid of any markings can be provided extending alongside the scale 40a and 40b to space the scale away from the adjacent side 12, 14 of the surface 10.

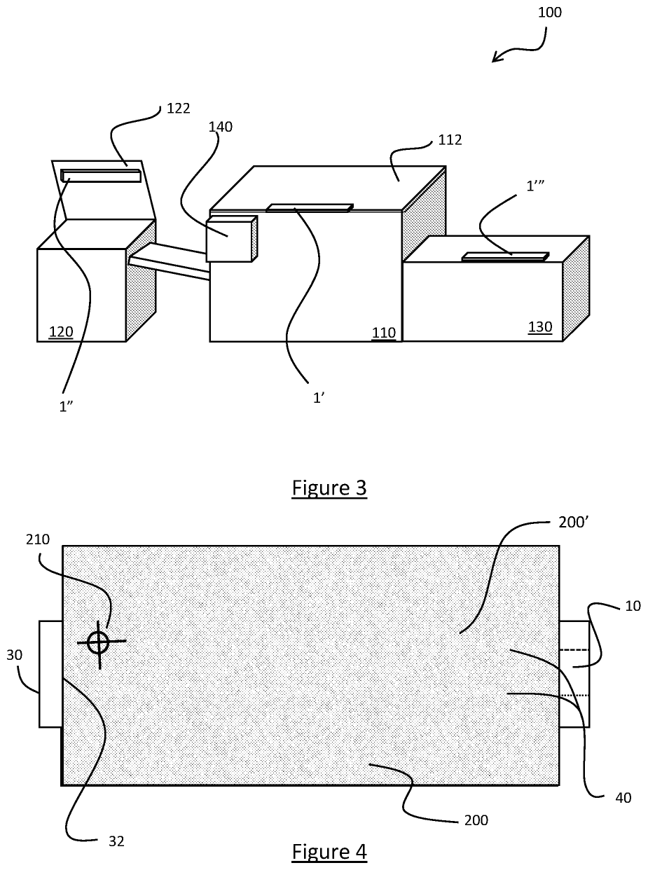

The measuring device 1 of some examples may be integrated into a print press 100 as shown in FIG. 3. The print press 100 may for example include a main print unit 110 and a stacker assembly 120. The stacker assembly 120 may be arranged to receive and accumulate output from the main print unit 110. The main print unit 110 may be the press engine. The print press may include a feed assembly 130. The feed assembly 130 may be arranged to supply print media to the main print unit 110. A measuring device 1 could be integrated into the main print unit 110 and/or into the stacker assembly 120 and/or into the feed assembly 130. The measuring device 1 may be integrated by being connected to a metal frame on or under a cover of the printer. The connection may for example be using screws such as Allen/hex screws. In some examples, the measuring device may be removably integrated into the print press 100. For example, the measuring device 1 may include a rechargeable battery such that it can be powered when detached from the print press and recharged when in situ. One convenient location for the measuring device 1 in some examples may be inside or on a cover of the print press 100. For example, measuring device 1′ is shown as an example of integration into a cover 112 of the main press, measuring device 1″ is shown as an example of integration into the stacker assembly 120 and measuring device 1″ is shown as an example of integration into the feed assembly 130. One or more integration location could be selected depending for example upon the ergonomics of the particular print press 100 on which the device is being provided. In the illustrated example the measuring device 1″ on the stacker 120 may be attached into the inner of the cover 122 and the measuring device 1′ can be on the outer of cover 112. It will be appreciated that either or both of these arrangements could be reversed in other examples of the disclosure. When the measuring device is attached to the inside of the cover 122 it may, for example, be positioned within a window or frame so that the planar surface 10 is accessible from the outer side in use.

In some implementations an upper cover 122, 112 of the print press 100 may provide a worksurface. For example, when working with larger print media it may be useful to have a worksurface, which may for example be generally planar and horizontally aligned, to support the media. The measuring device 1 may be provided on or integral to the worksurface such that an operator can easily position a printed media sample on the worksurface and use the measuring device 1. The print press 100 may include a user interface 140 (which may for example be a computer or a touchscreen). The measuring device 1 may be integrated into a work surface close to the user interface 140. This may allow the operator to make measurements or calibration checks using the measuring device and conveniently make adjustments to the print press through the user interface 140.

Use of a measuring device 1 according to an example will now be described with reference to FIG. 4. FIG. 4 shows example of an article of printed media 200 positioned on the surface 10 of a measuring device 1. The printed media is placed flat upon the planar surface 10 of the measuring device 1. The printed media 200 may include print on one or both sides and has a first face positioned on the planar surface 10 and an opposing face directed outwardly away from the measuring device 1. The printed media is slid toward the alignment guide 30 (i.e. to the left in the figure). An edge of the media 200 abuts the alignment edge 32 which ensures it is perpendicular to both the plane of the surface 10 and to the longitudinal axis of the measuring device 1. With the light source 20 (not shown in FIG. 4) of the device 1 illuminated, the section 200′ of the media which is overlying the surface 10 can be backlit by the measuring device. Whilst the illustrated example shows the central portion of the media 200 as the backlit section 200′ it will be appreciated that this can be easily repositioned. In the example, as the scale 40 is provided on the surface 10 and the light source 20 is beneath or embedded below the surface 10, the scale 40 of the measuring device 1 is projected such that it can be visible through the upper face of the illuminated section 200′ of the media 200. This can enable accurate measurement of features to be made on the surface of the media 200. As mentioned above, the scale 40 in the example is spaced away from the edges of the surface 10 by the margins 45. This may ensure that the illuminated section 200′ of the media 200 extends beyond the scale 40 and may be useful when aligning features to be measured with the scale 40.

In addition to measuring of features on the upper surface of the printed media 200, the measuring device of the example may also be used for front-to-back alignment of printing on the two faces of the media. By backlighting the media and providing a source of illumination which can pass through the media 200, examples can allow a user to identify and check alignment of features on the opposing sides. Since examples of this disclosure provide a scale 40 which is projected through the printed media 200, the scale can be visible to the user whilst examining alignment or other front-to-back features. As such in some examples, the scale can be used to determine the size of front-to-back issues which for correction. When printing a two-sided media article, the media may include an alignment indicator 210 (which whilst in the example is shown in a central region for clarity may be provided close to an edge or in an unused portion of the media 200). In the example the alignment indicator 210 comprises a cross printed on one side of the media and at least one circle printed on the other side of the media. The indicator 210 may be positioned so that when the front and back printing on the media 200 are in ideal alignment the cross and circle of the alignment indicator 210, on the opposing sides of the media, are concentric. The light source 20 of the device 1 may be relatively high intensity or may be adjusted in intensity until it is sufficient for both sides of the alignment indicator 210 to be seen through the backlighting. This can allow both sides of the alignment indicator 210 to be seen in super-positioned arrangement and any deviation from the intended concentric alignment determined and/or measured.

In addition to accurate measurement of substrates or printed images and front-to-back alignment, examples of the measurement device 1 may also be useful for identification of print quality defects. For example, the backlighting provided by the light source of examples may assist in visibility of defects. When a defect is identified, examples of the disclosure may be used to determine the fixed frequency at which a defect has occurred. Use of a measuring device according to an example of the present disclosure may allow the fixed frequency of such defects to be measured with a greater accuracy. Any fixed frequency of print defects may provide a defect “signature” which can be used to correlate the cause of the defect to parts of the print press (for example a specific roller within the press). As such, in some examples, the fixed frequency may be used to provide an indication of which part or parts of the print press should have corrective adjustment, cleaning and/or maintenance. Other implementations of the disclosure may for example be useful in determining repeat length or image length, for example to determine correct scaling of a print.

It may also be appreciated that the measuring device in accordance with the present disclosure can be adjusted depending upon the particular print press it is associated with. For example, a press may utilize media of particular dimensions or type and the scale and dimensions of the measuring device may be matched to the expected calibration or measurements that could be used for the given media.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A digital print press apparatus comprising a measuring device having:
a light transmitting planar surface;
a light source behind the surface to backlight the surface and project light through the surface; and
an opaque scale on the surface to provide visible scale markings projected through printed media placed upon the surface.

2. An apparatus as claimed in claim 1, wherein the measuring device is integrated into an outer surface of a cover of the digital print press apparatus.

3. An apparatus as claimed in claim 1, wherein the digital print press apparatus is a stacker assembly and wherein the measuring device is integral to an outer surface of the stacker.

4. An apparatus as claimed in claim 3, wherein the digital print press apparatus further comprises a print engine.

5. An apparatus as claimed in claim 1, wherein the digital print press apparatus comprises a worksurface to support printed media and wherein the worksurface includes the measuring device.

6. An apparatus as claimed in claim 1, wherein the light source is a variable intensity light source.

7. An apparatus as claimed in claim 1, wherein the planar surface extends from a first end to a second end and wherein the first end is provided with an alignment guide.

8. An apparatus as claimed in claim 7, wherein the alignment guide is an upstanding wall extending perpendicular to the plane of the surface.

9. An apparatus as claimed in claim 1, wherein the planar surface is elongate and the scale extends along the length of the surface and wherein the width of the surface is greater than the width of the scale.

10. An apparatus as claimed in claim 9, wherein the surface extends across the width from a first side to a second side and wherein the scale is offset from the first and second side by a margin free of opaque markings.

11. An apparatus as claimed in claim 1, wherein the scale comprises a plurality of scales.

12. An apparatus as claimed in claim 1, wherein the scale includes major and minor unit indications.

13. An apparatus as claimed in claim 1, further comprising a switch for activation of the light source.

14. An apparatus as claimed in claim 1, wherein the light source is an LED.

15. An apparatus as claimed in claim 14, wherein the light source is embedded beneath the surface.

16. A stacker assembly of a digital print press, the stacker assembly having a worksurface, the worksurface being provided with an integrated measuring and alignment device comprising:
a light source embedded beneath the worksurface;
a light transmitting region extending over the light source to project light through the worksurface; and
a non-light transmitting scale on the light transmitting region of the surface to provide to provide visible scale markings projected through printed media placed upon the surface.

17. An apparatus comprising
a digital print press to producing printed media and
a measuring and alignment device, the device comprising:
a planar surface to support printed media, at least a portion of the planar surface comprising a transparent or translucent material;
a light source to project light through the transparent or translucent material; and
at least one calibration scale extending over the light source to selectively block light transmission such that the scale is projected through printed media placed upon the planar surface.
